(19) United States
(12) Patent Application Publication
(10) Pub. No.: US 2026/0127521 A1
(43) Pub. Date: May 7, 2026

(54) FEATURE VECTORS FOR CLOUD INTEGRATION PROCESS FLOWS

(71) Applicant: SAP SE, Walldorf (DE)

(72) Inventors: Venkata Krishna KOTA, Bangalore (IN); Abhishek Bhaskar KULKARNI, Pune (IN); Nirmal Sivakumar G, Bangalore (IN)

(21) Appl. No.: 18/938,947

(22) Filed: Nov. 6, 2024

(51) Int. Cl. G06Q 10/0631

(52) U.S. Cl. CPC G06Q 10/06313

(57) ABSTRACT

A system associated with integration process flows in a cloud computing environment may include an integration process flow data store that contains information about a plurality of integration processes and an integration process feature vector data store that contains information about a plurality of integration process feature vectors. A feature vector creation engine may retrieve information about a first integration process flow from the integration process flow data store. The feature vector creation engine can then automatically analyze the retrieved information about the first integration process flow to create a first integration process feature vector that is stored into the integration process feature vector data store. A feature vector utilization engine may retrieve information about the first integration process feature vector and a second integration process feature vector from the integration process feature vector data store and perform an action based on the first and second integration process feature vectors.

### BACKGROUND

An enterprise may implement processes. For example, a company may implement business processes to handle sales orders, item deliveries, inventory monitoring, etc. Moreover, the processes may be automated in a cloud computing environment using integration models. There are many software applications and products that are based on such models where a developer creates a sequence of events or processes and the appropriate sequence of flow steps for the process. For example, SAP™ IFLOW® lets developers generate an integration process flow using a graphical model that contains endpoints and flow steps.

In some cases, it would be helpful to identify one or integration process flows that are similar to other flows based on the characteristics of the flows. For example, a developer might be interested in finding out that a new flow is a duplicate (or nearly a duplicate) of an existing flow to avoid redundancy. Similarly, a developer might want to know if a new flow is a duplicate (or nearly a duplicate) of another flow that has caused problems in the past. Manually identifying similar integration process flows, however, can a time-consuming and error prone task—especially when there are a substantial number of flows, the flows are very complicated, etc.

It would therefore be desirable to utilize feature vectors for integration process flows in a secure, automatic, and efficient manner.

### SUMMARY

According to some embodiments, methods and systems associated with integration process flows in a cloud computing environment may include an integration process flow data store that contains information about a plurality of integration processes and an integration process feature vector data store that contains information about a plurality of integration process feature vectors. A feature vector creation engine may retrieve information about a first integration process flow from the integration process flow data store. The feature vector creation engine can then automatically analyze the retrieved information about the first integration process flow to create a first integration process feature vector that is stored into the integration process feature vector data store. A feature vector utilization engine may retrieve information about the first integration process feature vector and a second integration process feature vector from the integration process feature vector data store and automatically perform an action based on the first and second integration process feature vectors.

Some embodiments comprise: means for retrieving information about a first integration process flow from an integration process flow data store that contains information about a plurality of integration processes; means for automatically analyzing, by the feature vector creation engine, the retrieved information about the first integration process flow to create a first integration process feature vector based on multiple characteristics of the first integration process flow; means for storing, by the feature vector creation engine, the first integration process feature vector into an integration process feature vector data store; means for retrieving, by a feature vector utilization engine, information about the first integration process feature vector and a second integration process feature vector from the integration process feature vector data store; and means for automatically performing, by the feature vector utilization engine, an action based on the first and second integration process feature vectors.

Some technical advantages of some embodiments disclosed herein are improved systems and methods to utilize feature vectors for integration process flows in a secure, automatic, and efficient manner.

### BRIEF DESCRIPTION OF THE DRAWINGS

FIG. 1A is a high-level system architecture in accordance with some embodiments.

FIG. 1B is an example of a Graphical User Interface (“GUI”) for an integration process flow.

FIG. 2 is a method according to some embodiments.

FIG. 3 is a system associated with adapter vectors in accordance with some embodiments.

FIG. 4 is a method associated with adapter vectors according to some embodiments.

FIG. 5 is an example associated with adapter vectors in accordance with some embodiments.

FIG. 6 is a system associated with resource vectors according to some embodiments.

FIG. 7 is a method associated with resource vectors in accordance with some embodiments.

FIG. 8 is an example associated with resource vectors according to some embodiments.

FIG. 9 is a system utilizing resource vectors in accordance with some embodiments.

FIG. 10 is a method utilizing resource vectors to generate worker application recommendations according to some embodiments.

FIG. 11 is a method utilizing resource vectors to integration process flow recommendations in accordance with some embodiments.

FIG. 12A is a method utilizing resource vectors to generate orchestration recommendations according to some embodiments.

FIG. 12B shows orchestration plan generation in accordance with some embodiments.

FIG. 12C shows worker categories according to some embodiments.

FIG. 12D shows service categories in accordance with some embodiments.

FIG. 12E shows available workers according to some embodiments.

FIG. 12F shows available services in accordance with some embodiments.

FIG. 12G shows iFlows according to some embodiments.

FIG. 12H shows an orchestration plan in accordance with some embodiments.

FIG. 13 is a method of translating orchestration recommendations in accordance with some embodiments.

FIG. 14 is a system associated with connection and usage statistics vectors system according to some embodiments.

FIG. 15 is a connection and usage statistics vectors method in accordance with some embodiments.

FIG. 16A is a similarity score system according to some embodiments.

FIG. 16B is an example associated with similarity scores according to some embodiments.

FIG. 17 is a similarity score method in accordance with some embodiments.

FIG. 18A is a cluster system according to some embodiments.

FIG. 18B is an example associated with clustering according to some embodiments.

FIG. 19 is a cluster method in accordance with some embodiments.

FIG. 20 is a classification system according to some embodiments.

FIG. 21 is a classification method in accordance with some embodiments.

FIG. 22 is a system according to some embodiments.

FIG. 23 is an apparatus or platform according to some embodiments.

FIG. 24 is a portion of a registration database in accordance with some embodiments.

FIG. 25 illustrates a tablet computer model flow display according to some embodiments.

FIG. 26 is a feature vector engine operator or administrator display in accordance with some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

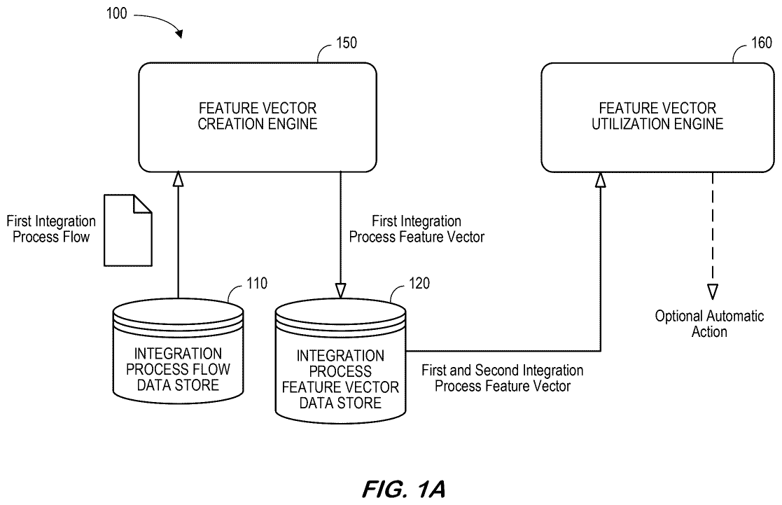

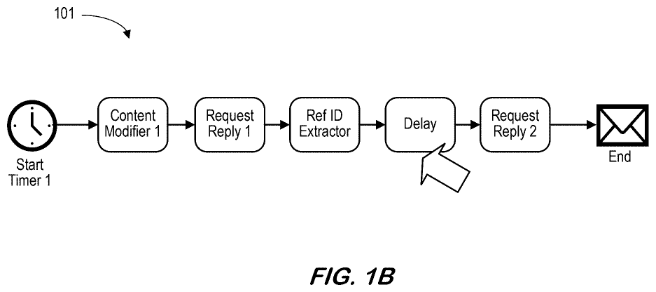

FIG. 1A is a high-level block diagram of one example of an integration process flow system 100 architecture according to some embodiments. In particular, a feature vector creation engine 150 may access information about a first integration process flow from an integration process flow data store 110. FIG. 1B is an example 101 of a GUI for an integration process flow. The integration process flow might, for example, be stored as an APACHE Camel® documents. Camel® is an open-source framework for message-oriented middleware with a rule-based routing and mediation engine that provides a Java object-based implementation of the enterprise integration pattern using an application programming interface to configure routing and mediation rules. Referring again to FIG. 1A, the feature vector creation engine 150 may then use characteristics of the first integration process to create a first integration process feature vector that is stored in an integration process feature vector data store 120. A feature vector utilization engine 160 can then access information about multiple integration process feature vectors and use that information to automatically perform one or more various actions as described herein. As used herein, the term “automatically” may refer to something that is performed with little or no human intervention. According to some embodiments, a remote operator or administrator device may be used to configure or otherwise adjust the system 100.

As used herein, devices, including those associated with the system 100 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The feature vector creation engine 150 may store information into and/or retrieve information from various data stores (e.g., the integration process flow data store 110 and/or integration process feature vector data store 120), which may be locally stored or reside remote from the feature vector creation engine 150. Although a single feature vector creation engine 150 is shown in FIG. 1, any number of such devices may be included. Moreover, various devices described herein might be combined according to embodiments of the present invention. For example, in some embodiments, the integration process flow data store 110 and the feature vector creation engine 150 might comprise a single apparatus. The system 100 functions may be performed by a constellation of networked apparatuses, such as in a distributed processing or cloud-based architecture. In some cases, the feature vector creation engine 150 may process information associated with a number of different enterprises.

The enterprise may access the system 100 via a remote device (e.g., a Personal Computer (“PC”), tablet, or smartphone) to view information about and/or manage operational information in accordance with any of the embodiments described herein. In some cases, an interactive Graphical User Interface (“GUI”) display may let an operator or administrator define and/or adjust certain parameters via a remote device (e.g., to specify a request action for an enterprise computing environment infrastructure) and/or provide or receive automatically generated recommendations, alerts, summaries, or results associated with the system 100.

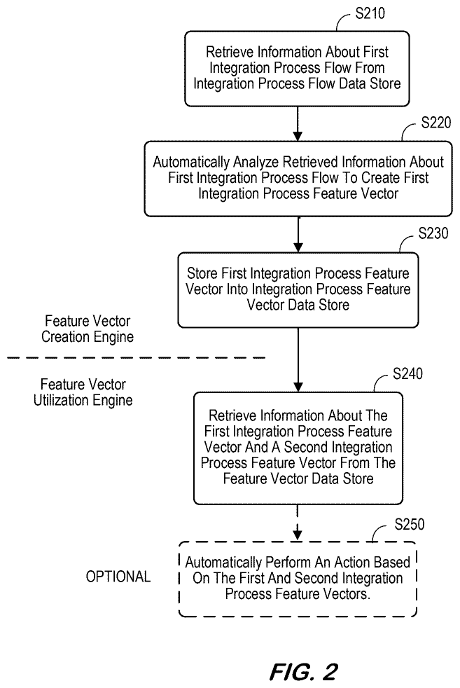

FIG. 2 is a method that might be performed by some or all of the elements of the system 100 described with respect to FIG. 1. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, a feature vector creation engine may retrieve information about a first integration process flow from an integration process flow data store that contains information about a plurality of integration processes. At S220, the feature vector creation engine may automatically analyze the retrieved information to create a first integration process feature vector based on multiple characteristics of the first integration process flow. A feature vector might be derived, for example, using components, contents, and/or other details of that integration flow. Note that vectors might be created manually or using computer driven methods. At S230, the feature vector creation engine may store the first integration process feature vector into an integration process feature vector data store.

At S240, a feature vector utilization engine can then retrieve information about the first integration process feature vector and a second integration process feature vector from the integration process feature vector data store. At S250, the feature vector utilization engine may optionally automatically perform an action based on the first and second integration process feature vectors in accordance with any of the embodiments described herein. For example, a user may select a directory containing integration process flow files. The system may then extract required feature vectors from integration process flow files (e.g., an adapter vector, a resource vector, a connection vector, etc.). In some embodiments, the information may be retrieved from logs or databases of an SAP™ Cloud Platform Integration® (“CPI”) platform that lets organizations connect different systems, applications, and data sources (both inside and outside of) enterprise landscape.

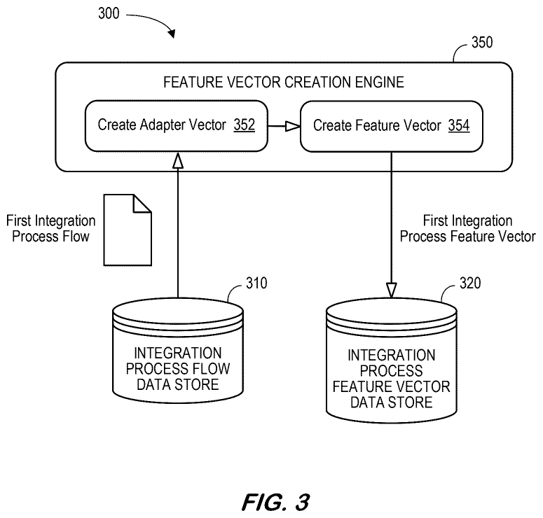

Consider, for example, FIG. 3 which is a system 300 associated with adapter vectors in accordance with some embodiments. In particular, a create adapter vector 352 of a feature vector creation engine 350 may access information about a first integration process flow from an integration process flow data store 310. The create adapter vector 352 may then generator an adapter vector. A create feature vector 354 of the feature vector creation engine 350 can then use the adapter vector to create a first integration process feature vector which is stored in an integration process feature vector data store 320.

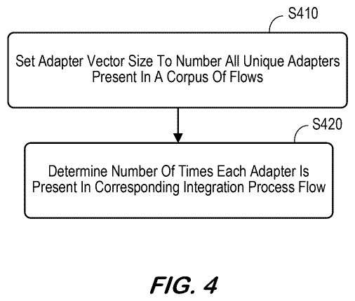

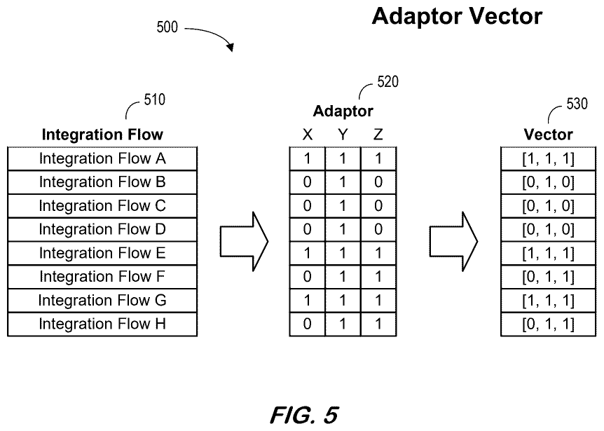

FIG. 4 is a method associated with adapter vectors according to some embodiments. At S410, the system sets the size of the adapter vector to the number all unique adapters that are present in a corpus of integration process flows (e.g., a directory containing eight flows, hundreds of flows, etc.). At S420, the values of the vector are determined as non-negative integers indicating a number of times each adapter is present in the corresponding flow. FIG. 5 is an example 500 associated with adapter vectors in accordance with some embodiments. The example 500 includes eight integration process flows 510 (flows A through H). The system has determined that there are three unique adapters 520 (adapters X, Y, and Z) used in all eight of the integration flows 510. For each adapter 520 in each integration flow 510, the system counts how many times it was utilized. In the example, adapter X was not used in integration flow F and adapters Y and X were each used one time. Since there were three unique adapters 520 in the eight integration flows 510, the size of the adapter vector 530 is three and its value is [0, 1, 1]. Note that when there are a substantial number of integration flows, the size of the adapter vector 530 could be very large).

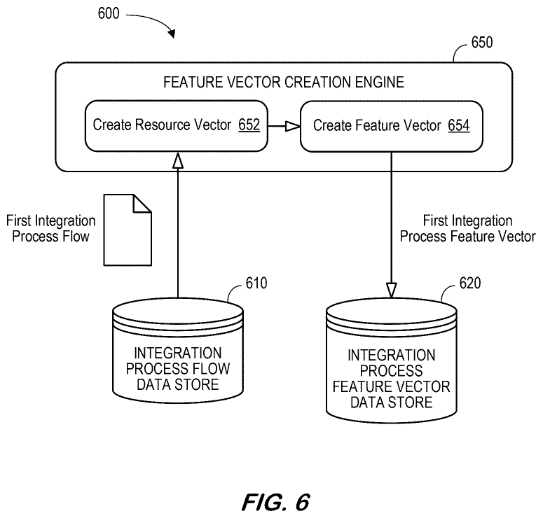

In addition to (or instead of) adapter vectors, embodiments may utilize a vector representation for flow resources (e.g., database resources, file system resources, Java Messaging System (“JMS”) resources, etc.). FIG. 6 is a system 600 associated with resource vectors according to some embodiments. In particular, a create resource vector 652 of a feature vector creation engine 650 may access information about a first integration process flow from an integration process flow data store 610. The create resource vector 652 may then generator a resource vector. A create feature vector 654 of the feature vector creation engine 650 can then use the resource vector to create a first integration process feature vector which is stored in an integration process feature vector data store 620.

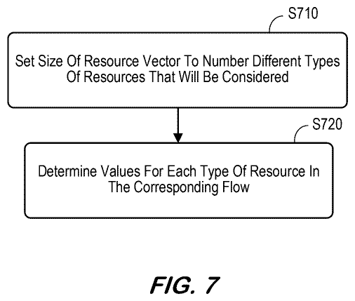

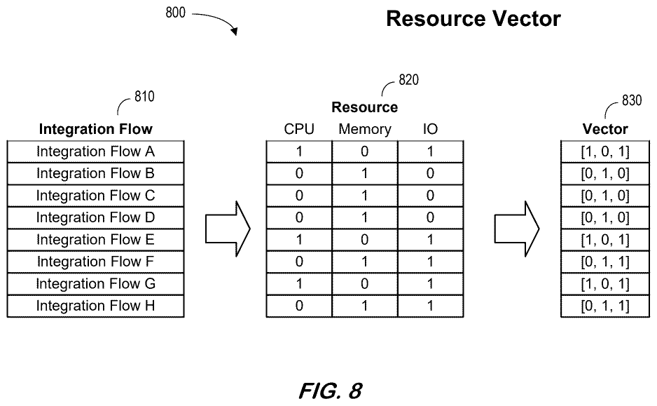

FIG. 7 is a method associated with resource vectors in accordance with some embodiments. At S710, the system sets the size of the resource vector based on a number of different resource types that will be considered (e.g., CPU resources, memory resources, and Input Output (“IO”) resources). According to some embodiments, for a given integration process flow, for each of its adapters, the system aggregates the resource usage quantities. In this way, a total amount of resources required and/or consumed by each type of resource can be determined. In this way, the values of the resource vectors may be determined for in the corresponding flow at S720. FIG. 8 is an example 800 associated with resource vectors according to some embodiments. As before, the example 800 includes eight integration process flows 810 (flows A through H). The system has determined that there are three different types of resources 820 (CPU, memory, and IO). For each type of resource 820 in each integration flow 810, the system measures utilization. In the example, one unit of CPU resource was utilized for integration flow A, zero units of memory were utilized, and one unit of IO was utilized. Since there were three different types of resources 820, the size of the resource vector 830 is three and its value is [1, 0, 1].

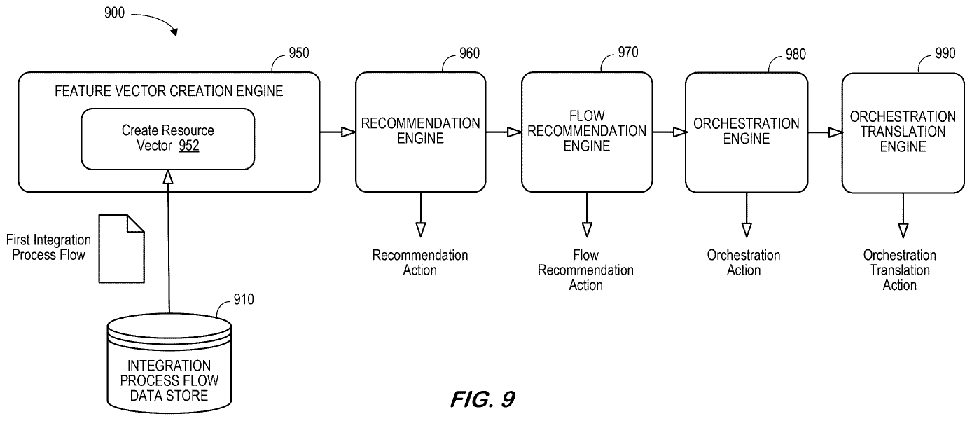

Note that such a resource vector might be used for a number of different actions. In particular, FIGS. 9 through 13 provide various examples of uses for a resource vector. FIG. 9 is a system 900 utilizing resource vectors in accordance with some embodiments. As before, a create resource vector 952 of a feature vector creation engine 950 may access information about a first integration process flow from an integration process flow data store 910. The create resource vector 952 may then generator a resource vector.

This resource vector can then be provided to a recommendation engine 960, a flow recommendation engine 970, an orchestration engine 980, and/or an orchestration translation engine 990.

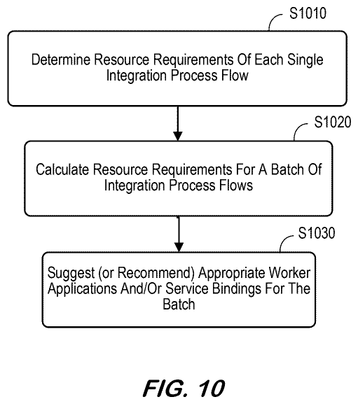

Thus, the system 900 may may determine resource requirements for any given integration process flows. Generally, a batch of integration process flows are selected and deployed to a worker application. For this, it is desirable to pick a worker application that will be a good choice for that batch of integration process flows (with respect to the resource requirements). FIG. 10 is a method utilizing resource vectors to generate worker application recommendations according to some embodiments. The system determines the resource requirements of each single integration process flow at S1010. Embodiments may then calculate resource requirements for a batch of integration process flows at S1020. When the resource requirements for the batch of integration process flows is known, at S1030 the system suggests (or recommends) appropriate worker applications and/or service bindings accordingly (e.g., based on integration process flows, available worker applications, and available service bindings). In some embodiments, vector representations for servers (virtual machines, containers, nodes, pods, etc.) may be determined. The server vectors can be derived, for example, using the characteristics of each server such as the CPU resources, memory resources, database resources, etc.

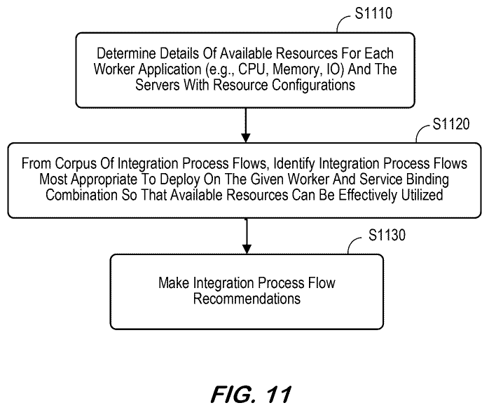

FIG. 11 is a method utilizing resource vectors to make integration process flow recommendations in accordance with some embodiments. That is, at S1110 the system determines the details of available resources for each worker application (e.g., CPU, memory, IO) and the servers with resource configurations. Then, from a corpus of integration process flows, embodiments may identify the integration process flows that are most appropriate to deploy on the given worker and service binding combination at S1120 such that available resources are effectively utilized. Embodiments may then make integration process flow recommendations at S1130 (e.g., based on integration process flows, available worker applications, and available service bindings).

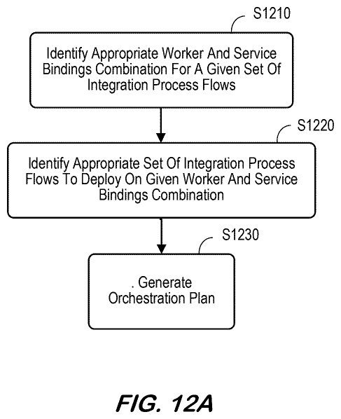

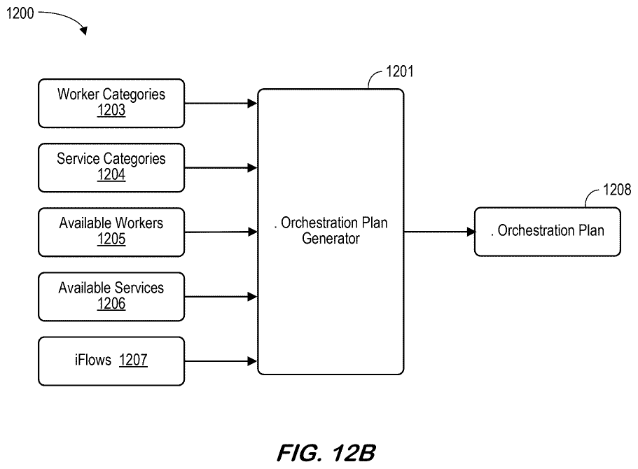

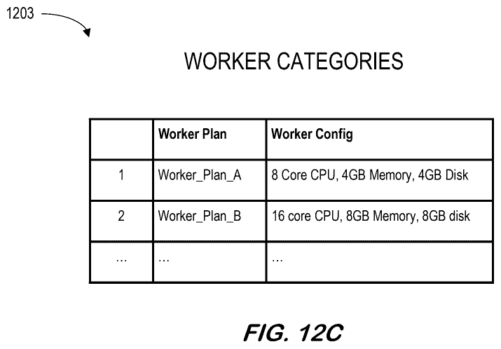

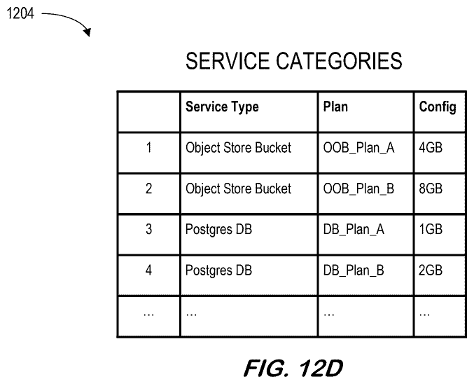

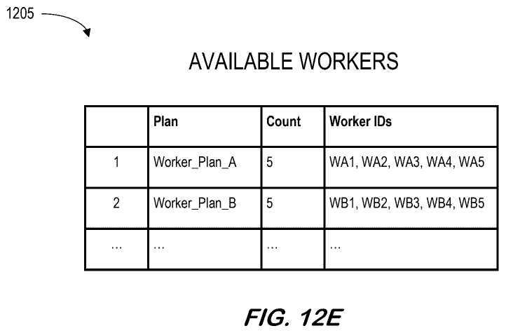

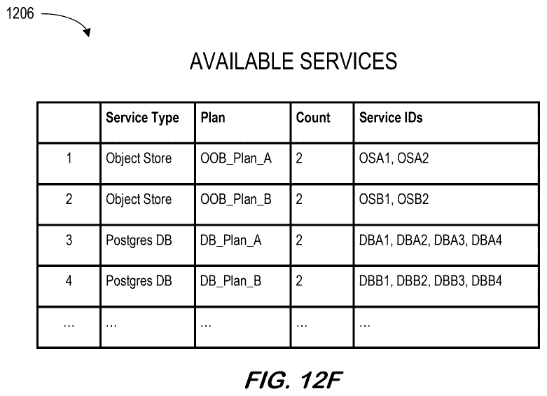

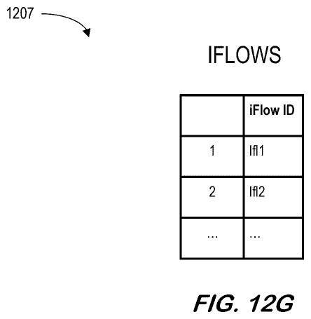

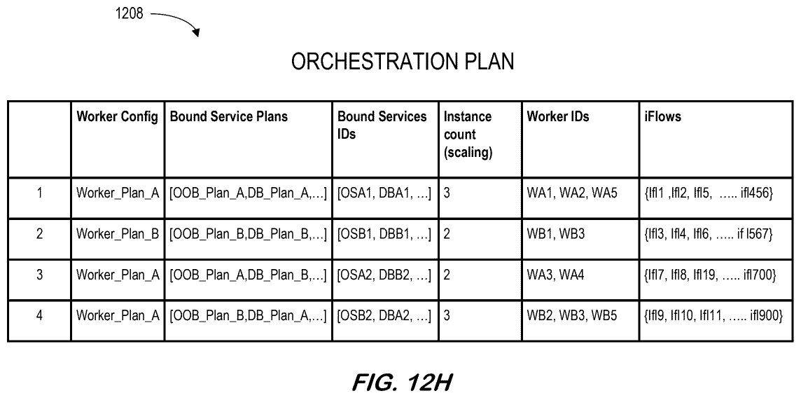

FIG. 12A is a method utilizing resource vectors to generate orchestration recommendations according to some embodiments. At S1210, the system identifies an appropriate worker and service bindings combination for a given set of integration process flows. At S1220, the system identifies an appropriate set of integration process flows to deploy on the given worker and service bindings combination. Such an approach allows for orchestration plan generation at S1230. For example, a user may give a set of integration process flows, worker details, and services details as an input. The system can then provide an appropriate orchestration plan as an output. The orchestration plan may, for example, describe which integration process flows should be deployed on which worker application as well as which services should be bound to it.

As used herein, the phrase “orchestration plan” may define how to deploy content (e.g., iFlows) among the available resources (e.g., workers and services). Note that services may be bound to a worker and iFlows may be deployed on workers. For example, FIG. 12B shows orchestration plan generation 1200 in accordance with some embodiments. An orchestration plan generator 1201 may receive, for example, the following inputs: worker categories 1203 (described in connection with FIG. 12C); service categories 1204 (described in connection with FIG. 12D); available workers 1205 (described in connection with FIG. 12E); available services 1206 (described in connection with FIG. 12F); and iFlows 1207 (described in connection with FIG. 12G). The orchestration plan generator 1201 can then use those inputs to create an orchestration plan 1208 (described in connection with FIG. 12H).

FIG. 12C shows the worker categories 1203 according to some embodiments. The worker categories 1203 might include, for example, information about worker plans, worker configurations (e.g., a number of core CPUs, memory, and disk space), etc. FIG. 12D shows the service categories 1204 in accordance with some embodiments. The service categories 1204 might include, for example, information about service types (e.g., object store buckets and Postgres databases), service plans, configurations, etc. FIG. 12E shows the available workers 1205 according to some embodiments. The available workers 1205 might include, for example, information about plans, counts, worker identifiers, etc. FIG. 12F shows the available services 1206 in accordance with some embodiments. The available services 1206 might include, for example, information about service types (e.g., object store buckets and Postgres databases), plans, counts, service identifiers, etc. FIG. 12G shows the iFlows 1207 according to some embodiments. The iFlows 1207 might include, for example, information about iFlow identifiers. FIG. 12H shows the orchestration plan 1208 that is automatically generated in accordance with some embodiments. The orchestration plan 1208 might include, for example, information about worker configurations, bound service plans, bound service identifiers, instance counts (for scaling), sets of worker identifiers, etc.

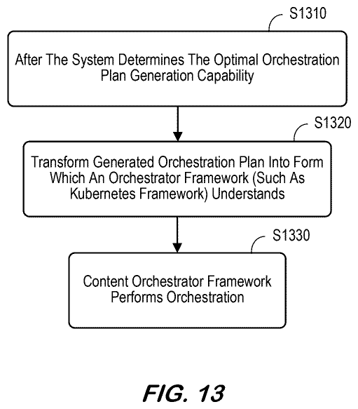

FIG. 13 is a method of translating orchestration recommendations in accordance with some embodiments. After the system determines the optimal orchestration plan generation capability at S1310, the system can transform the generated orchestration plan into a form or language which an orchestrator framework (such as a kubernetes framework) understands at S1320. Once available, the content orchestrator framework (such as kubernetes) performs the orchestration at S1330. For example, the user may provide the details of available integration process flows, worker details, and services. The system can then recommend an appropriate orchestration recommendation, translate that orchestration recommendation, and perform the automated orchestration providing an end-to-end optimal orchestration solution.

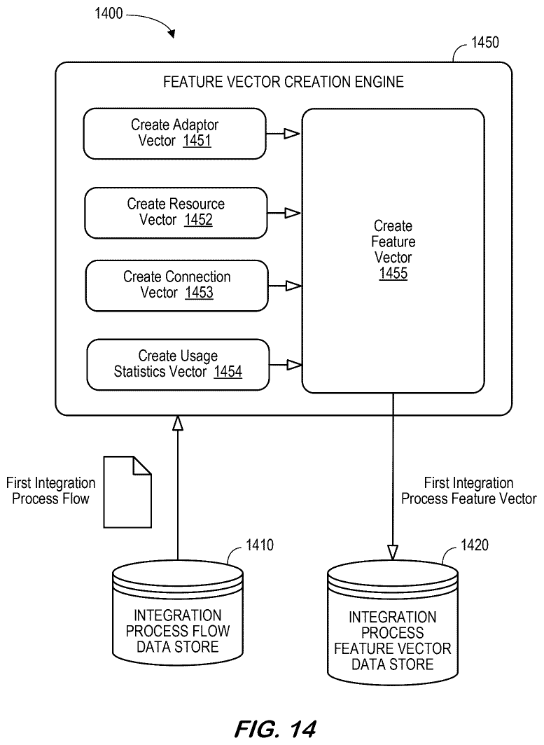

FIG. 14 is a system 1400 associated with connection and usage statistics vectors system according to some embodiments. As before, a create adapter vector 1451 of a feature vector creation engine 1450 may access information about a first integration process flow from an integration process flow data store 1410. Similarly, a create resource vector 1452 of the feature vector creation engine 1450 may access information about the first integration process flow, a create connection vector 1453 of the feature vector creation engine 1450 may access information about a first integration process flow, and a create usage statistics vector 1454 of the feature vector creation engine 1450 may access information about the first integration process flow. Each of these elements 1451, 1452, 1453, 1454 output vectors to a create feature vector 1455 of the feature vector creation engine 1450 uses the vectors to create a first integration process feature vector that is stored in an integration process feature vector data store 1420.

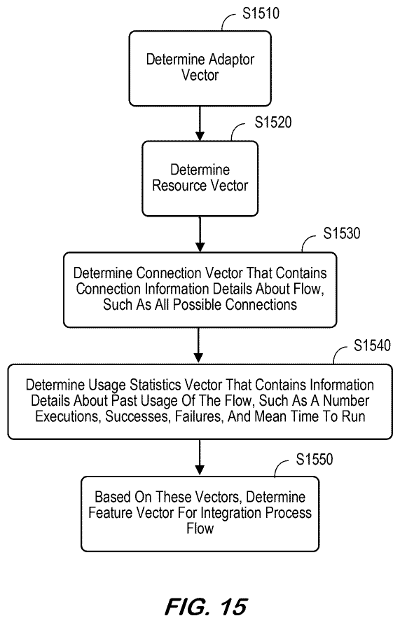

FIG. 15 is a connection and usage statistics vectors method in accordance with some embodiments. At S1510, an adapter vector may be determined as described in connection with FIGS. 3 through 5. At S1520, a resource vector may be determined as described in connection with FIGS. 6 through 8. At S1530, a connection vector may be determined that contains connection information details about a flow, such as all possible connections. At S1540, a usage statistics vector may be determined that contains information details about past usage of the flow, such as a number of executions, successes, failures, mean time to run, etc. Based on these vectors, a feature vector for the integration process flow can then be determined at S1550.

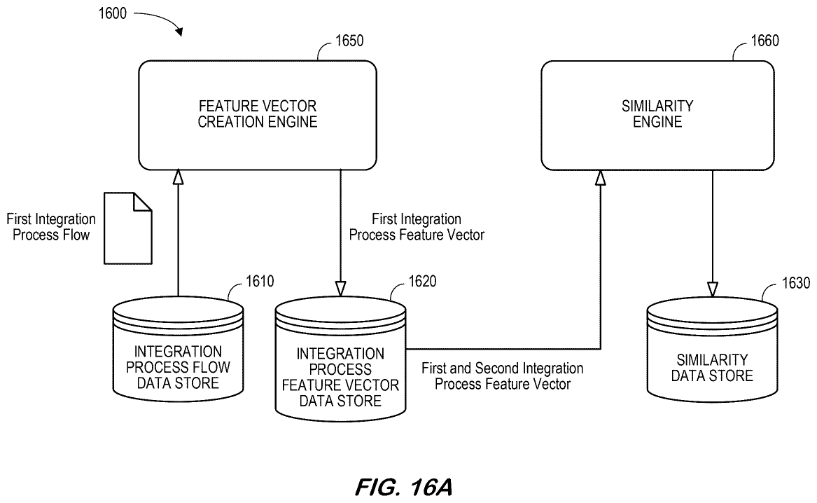

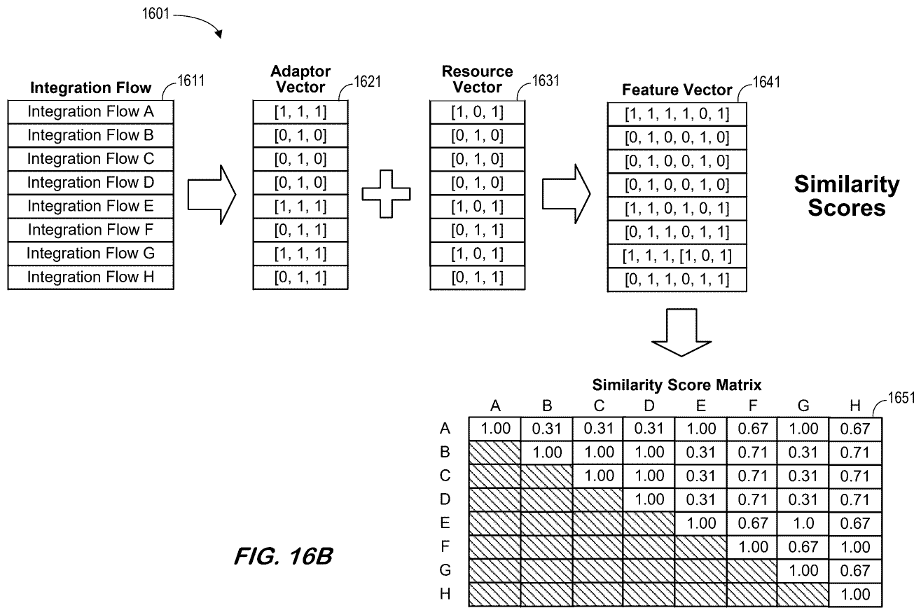

After integration process flows are represented as vectors, embodiments may determine integration process flow similarity (e.g., to identify the similarity between any pair of integration process flows) using a cosine similarity approach (or similar technique). FIG. 16A is a similarity score system 1600 according to some embodiments. As before, a feature vector creation engine 1650 may access information about a first integration process flow from an integration process flow data store 1610. The feature vector creation engine 1650 may then use characteristics of the first integration process to create a first integration process feature vector that is stored in an integration process feature vector data store 1620. A similarity engine 1660 can then access information about first and second integration process feature vectors and use that information to automatically update a similarity data store 1630 (e.g., an update based on a similarity matrix).

FIG. 16B is an example 1601 associated with similarity scores according to some embodiments. The example 1601 includes eight integration process flows 1611 (flows A through H). The system determines an adapter vector 1621 as described in connection with FIGS. 3 through 5 and a resource vector 1631 as described in connection with FIGS. 6 through 8. The adapter vector 1621 and resource vector are combined to form a feature vector 1641 for each of the eight integration flows 1611. The vectors 1621, 1631 may be combined, for example, using vector addition or any other type of vector transformation. According to some embodiments, weights are provided for elements of the feature vector (e.g., CPU utilization might be considered more important than memory usage when determining similarity). A similarity matrix 1651 can then be constructed comparing each of the eight integration flows 1611 to each of the other flows in the group. The matrix 1651 includes cells with similarity values from zero (completely dissimilar flows) to one (identical flows). The cross-hatched cells in FIG. 16B represent redundant values (that is, the similarity of flow B to flow F would be the same as the similarity of flow F to flow B).

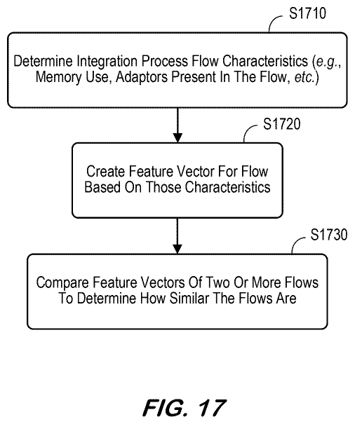

In this way, embodiments may create an integration process flow feature vector (the vector representation of integration process flow) by combining the adapter vectors 1621 and resource vectors 1631. If both the adapter and resource vector 1621, 1631 have a size of three, the overall feature vector size for integration process flow feature vector 1641 is six. Note that embodiments may also consider connection vectors, usage vectors, etc. to build the integration process flow feature vectors 1641. FIG. 17 is a similarity score method in accordance with some embodiments. At S1710, the system may determine integration process flow characteristics (e.g., memory use, adapters present in the flow, etc.). At S1720, the system creates a feature vector for the flow based on those characteristics. At S1730, the feature vectors of two or flows are compared to determine how similar the flows are.

After the system determines integration process flow similarity, it can retrieve familiar integration process flows. For example, an enterprise may have many integration process flows in a library. If a user selects any integration process flow, the system can retrieve integration process flows that are similar to that flow. For example, given an integration process flow embodiments might identify “nearly redundant” integration process flows (e.g., to avoid duplication or to help guide a developer). For a vulnerable integration process flow (e.g., one that causes a worker to fail), embodiments may find all similar integration process flows that may cause the same problem, etc.

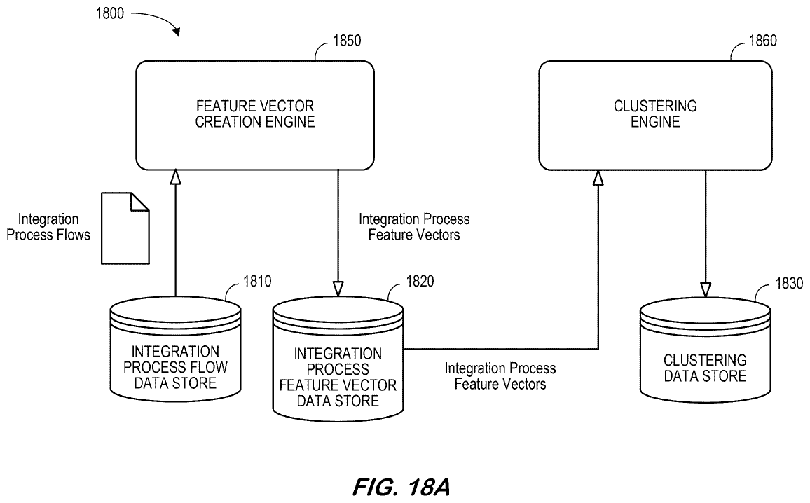

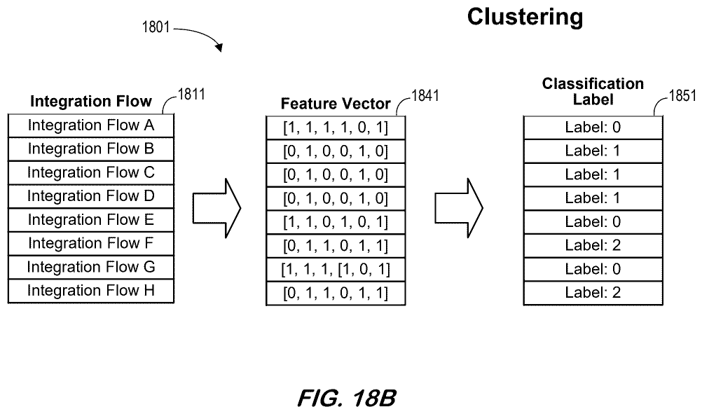

According to some embodiments, similarity-based methods may be used to select a resource (among existing resources) that might be appropriate for a particular resource or feature vector. That is, after a group of integration process flows are represented as vectors, embodiments may identify clusters of integration process flows. FIG. 18A is a cluster system 1800 according to some embodiments. As before, a feature vector creation engine 1850 may access information about integration process flows from an integration process flow data store 1810. The feature vector creation engine 1850 may then use characteristics of the integration process flows to create integration process feature vectors that are stored in an integration process feature vector data store 1820. Given this corpus of integration process flow feature vectors, a clustering engine 1860 sorts them into different clusters (based on the characteristics of the integration process flows) and stores the result in a clustering data store 1830.

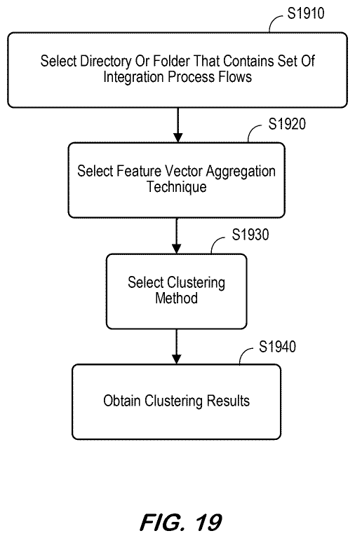

FIG. 186B is an example 1801 associated with clustering according to some embodiments. As before, the example 1801 includes eight integration process flows 1811 (flows A through H). The system determines feature vectors 1841 for each of the eight integration flows 1811. In this case, the system performs integration process flow classification to identify each cluster as belonging in one of three clusters 1851 (label 0, label 1, and label 2) 1851. FIG. 19 is a cluster method in accordance with some embodiments. At S1910, a user selects a directory or folder that contains a set of integration process flows. At S1920, the user selects a feature vector aggregation technique. At S1930, the user selects a clustering method. For example, the user might select k-means clustering approach or any other clustering method to cluster them into k clusters or labels. At S1940, the user may obtain the clustering results. Thus, when integration process flows are represented as vectors, the flows can be clustered using unsupervised learning clustering methods (such as k-means clustering, Density-Based Spatial Clustering of Applications with Noise (“DBSCAN”), etc.). These clusters describe the nature of related integration process flows. Such an approach may help a user understand the nature of integration process flows, determine resource requirements, estimate scaling characteristics, etc.

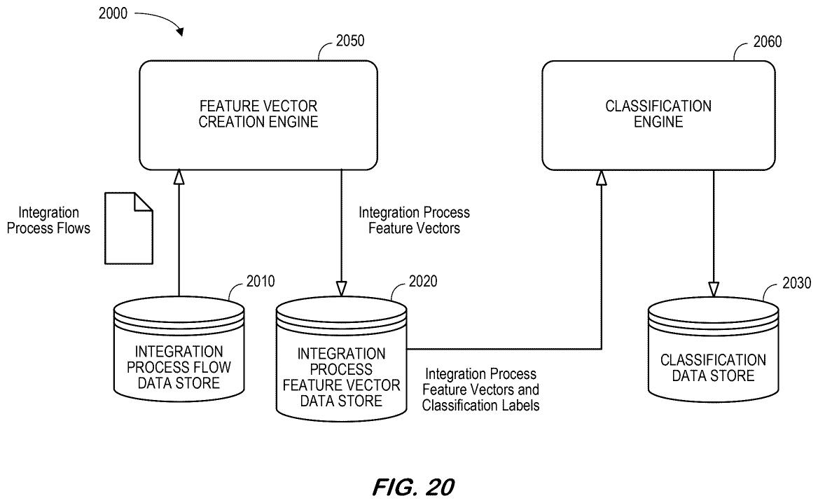

Some embodiments attach a label to each integration process flow vector and use it as training data for supervised learning algorithms. In this way a system can classify a new (or unseen) integration process flow. According to some embodiments, classification of an integration process flow is based on a business case. Flows might be classified, for example, as: standard or nonstandard (e.g., does the flow conform with enterprise guidelines?); safe or unsafe; CPU heavy or not CPU heavy; memory heavy or not memory heavy; IO heavy or not IO heavy; vulnerable or not vulnerable, etc. FIG. 20 is a classification system 2000 according to some embodiments. As before, a feature vector creation engine 2050 may access information about integration process flows from an integration process flow data store 2010. The feature vector creation engine 2050 may then use characteristics of the integration process flows to create integration process feature vectors that are stored in an integration process feature vector data store 2020. Given this corpus of integration process flow feature vectors and a set of associated training labels, a classification engine 2060 learns how to classify feature vectors and stores the result in a classification data store 2030.

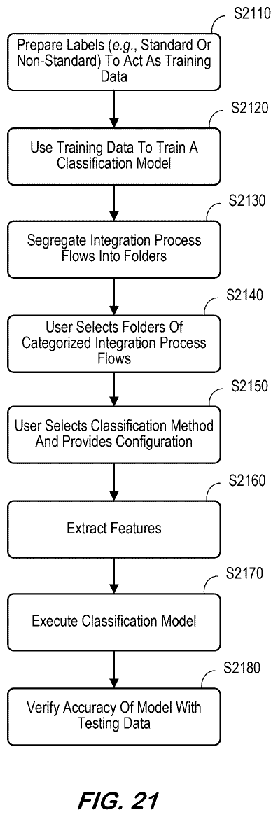

FIG. 21 is a classification method in accordance with some embodiments. At S2110, labels may be prepared (e.g., standard or non-standard) for a set of integration process flows to act as training data. At S2120, the training data is used to train a classification model to classify new integration process flows as either a standard integration process flow or a non-standard flow. At S2130, the integration process flows are segregated into two or more folders (one for each category). At S2140, a user selects the folders of the categorized integration process flows. At S2150, the user selects a classification method and provides any required configuration information for that method. At S2160, the system extracts the features in accordance with any of the embodiments described herein. At S2170, the system executes the classification model. Finally, at S2180 the accuracy of the model is verified with a set of testing data.

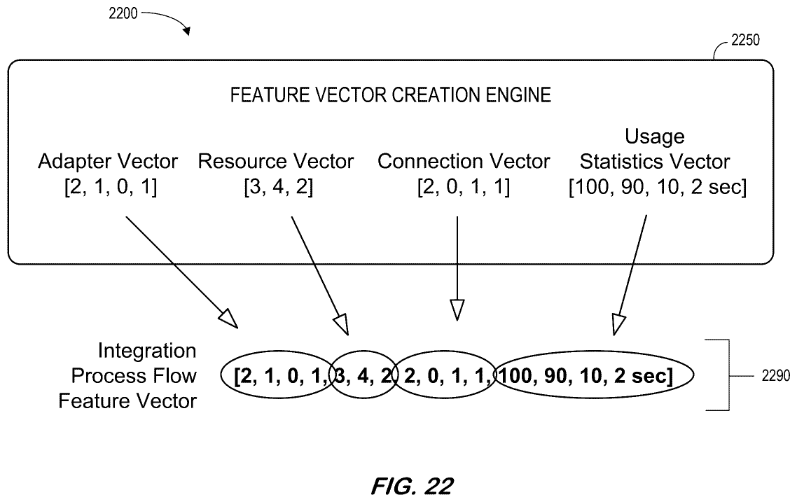

Feature vectors may be extracted such that the features most relevant to a use case are represented. For example, FIG. 22 is a system 2200 according to some embodiments. A feature vector creation engine 2250 determines an adapter vector based on all of the possible adapters an integration process flow might contain (e.g., [Java Database Connectivity (“JDBC”), Remote Function Call (“RFC”), Facebook] or “[2, 1, 0, 1]”). The feature vector creation engine 2250 also determines a resource vector based on amounts of various types of resources that an integration process flow will require (e.g., [CPU, memory, IO] or “[3, 4, 2]”). In addition, the feature vector creation engine 2250 determines a connection vector based on all of the possible connections an integration flow process contains (e.g., “[2, 0, 1, 1]”). The feature vector creation engine 2250 also determines a usage statistics or metrics vector based on details about past executions of the integration process flow (e.g., [number of executions, successes, failures, mean time to run] or “[100, 90, 10, 2 sec]”). A final integration process flow feature vector 2290 is then generated using all of these vectors (and, depending on the use case, weights might be selected for vectors).

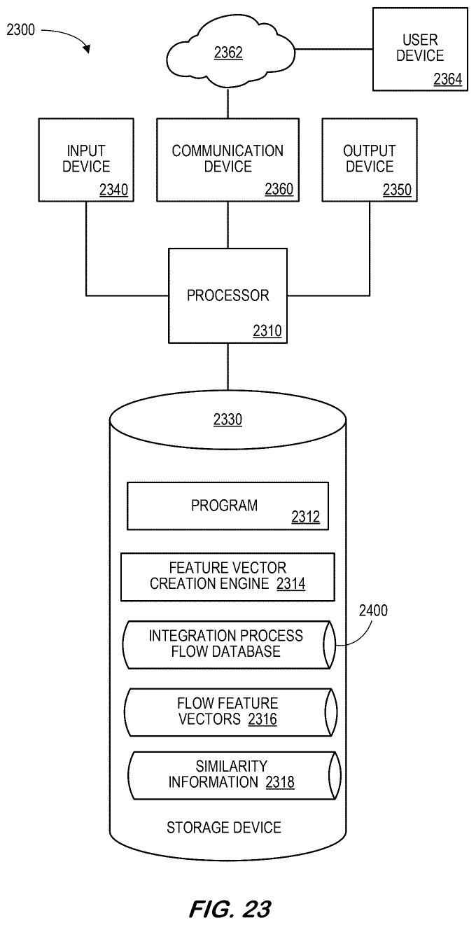

Note that the embodiments described herein may be implemented using any number of different hardware configurations. For example, FIG. 23 is a block diagram of an apparatus or platform 2300 that may be, for example, associated with the system 100 of FIG. 1A (and/or any other system described herein). The platform 2300 comprises a processor 2310, such as one or more commercially available Central Processing Units (“CPUs”) in the form of one-chip microprocessors, coupled to a communication device 2360 configured to communicate via a communication network 2362. The communication device 2360 may be used to communicate, for example, with one or more user devices 2364 via a distributed computer network 2362. The platform 2300 further includes an input device 2340 (e.g., a computer mouse and/or keyboard to input integration file information, categorization and classification options, etc.) and/an output device 2350 (e.g., a computer monitor to render a display, transmit recommendations, charts, alerts, and/or reports about an integration process flow, etc.).

The processor 2310 also communicates with a storage device 2330. The storage device 2330 may comprise any appropriate information storage device, including combinations of magnetic storage devices (e.g., a hard disk drive), optical storage devices, mobile telephones, and/or semiconductor memory devices. The storage device 2330 stores a program 2312 and/or feature vector creation engine 2314 for controlling the processor 2310. The processor 2310 performs instructions of the programs 2312, 2314, and thereby operates in accordance with any of the embodiments described herein. For example, the processor 2310 may retrieve information about a first integration process flow. The processor 2310 can then automatically analyze the retrieved information about the first integration process flow to create a first integration process feature vector. Information about the first integration process feature vector and a second integration process feature vector may cause the processor 2310 to automatically perform an action.

The programs 2312, 2314 may be stored in a compressed, uncompiled and/or encrypted format. The programs 2312, 2314 may furthermore include other program elements, such as an operating system, clipboard application, a database management system, and/or device drivers used by the processor 2323 to interface with peripheral devices.

As used herein, information may be “received” by or “transmitted” to, for example: (i) the platform 2300 from another device; or (ii) a software application or module within the platform 2300 from another software application, module, or any other source.

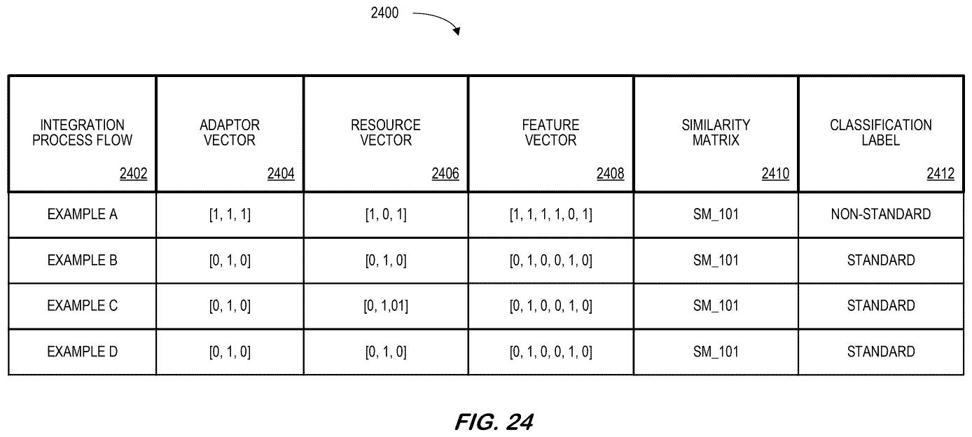

In some embodiments (such as the one shown in FIG. 23), the storage device 2330 further stores an integration process flow database 2400, flow feature vectors 2316, similarity information 2318, etc. An example of a database that may be used in connection with the platform 2300 will now be described in detail with respect to FIG. 24. Note that the database described herein is only one example, and additional and/or different information may be stored therein. Moreover, various databases might be split or combined in accordance with any of the embodiments described herein.

Referring to FIG. 24, a table is shown that represents the integration process flow database 2400 that may be stored at the platform 2300 according to some embodiments. The table may include, for example, entries identifying information process flows to be analyzed. The table may also define fields 2402, 2404, 2406, 2408, 2410, 2412 for each of the entries. The fields 2402, 2404, 2406, 2408 may, according to some embodiments, specify: an integration process flow 2402, an adaptor vector 2404, a resource vector 2406, a feature vector 2408, a similarity matrix 2410, and a classification label 2412. The integration process flow database 2400 may be created and updated, for example, when a user selects one or more information flows for analysis, feature vectors are computed, etc.

The integration process flow 2402 might be a unique alphanumeric label that is associated with a file name or location associated with an integration process flow and follows the example 1601 described in connection with FIG. 16B. The adaptor vector 2404 shows how many times each possible adapter appears in the integration flow. The resource vector 2406 indicates how much of various types of resources are required by the information flow. The feature vector 2408 is a combination of the adaptor vector 2404 and the resource vector 2406. The similarity matrix 2410. The classification label 2412 might indicate if the integration flow is standard or non-standard, good or bad, etc.

In this way, embodiments may utilize feature vectors for integration process flows in a secure, automatic, and efficient manner. Embodiments may help identify redundant or nearly duplicate flows, classify a flow is as standard or non-standard, classify a flow as good or bad (e.g., faulty and/or more vulnerable to crash).

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with some embodiments of the present invention (e.g., some of the information associated with the databases described herein may be combined or stored in external systems). Moreover, although some embodiments are focused on particular types of process applications, any of the embodiments described herein could be applied to other types of modelling applications.

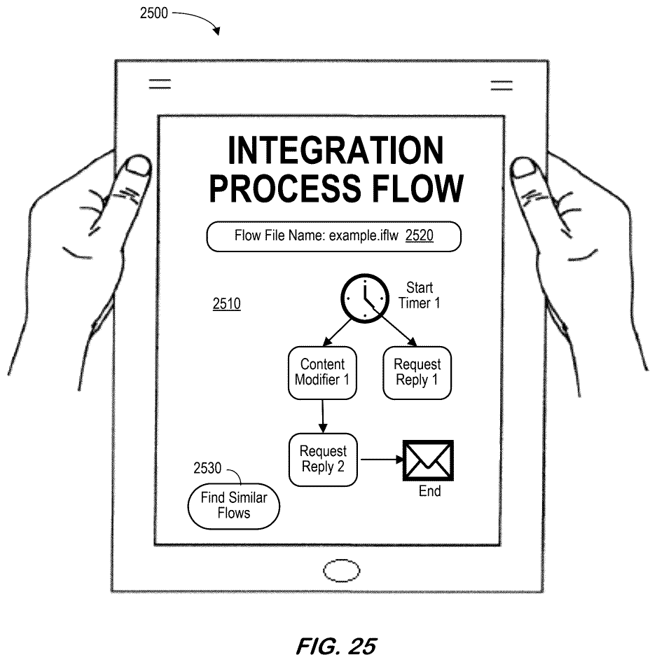

In addition, the displays shown herein are provided only as examples, and any other type of user interface could be implemented. For example, FIG. 25 illustrates a tablet computer 2500 providing an integration process flow display 2510 according to some embodiments. The display 2510 might be used, for example, to define or adjust an integration process (as identifying by the file name 2520) for an enterprise. A user may interact with the display 2510, such as by selecting a “Find Similar Flows” icon 2530 to locate duplicate (or nearly duplicate) flows.

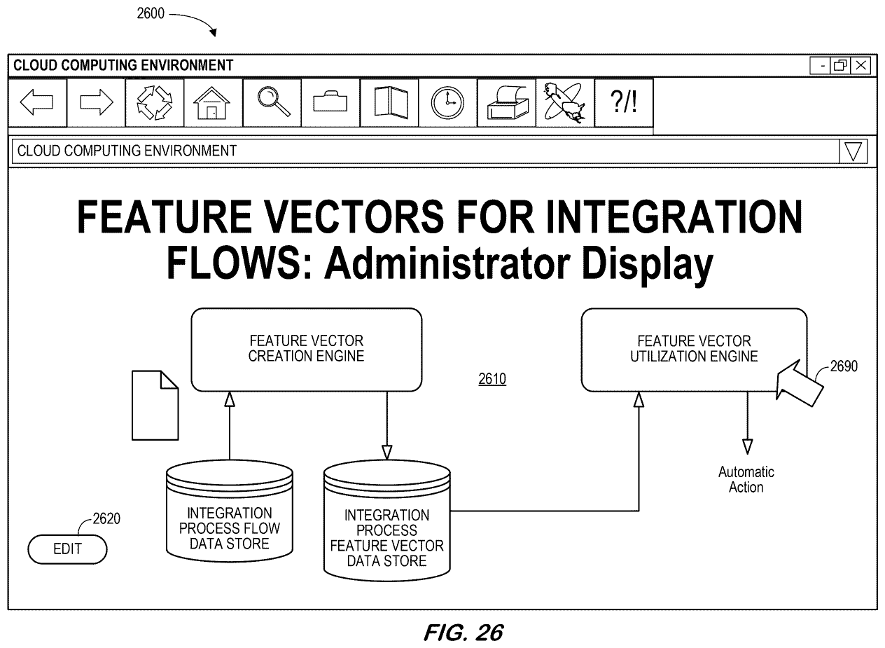

FIG. 26 is an operator or administrator display 2600 in accordance with some embodiments. The display 2600 includes a graphical representation 2610 of an integration flow analysis system in accordance with any of the embodiments described herein. Selection of an element on the display 2600 (e.g., via a touchscreen or computer pointer 2690) may result in display of a pop-up window containing more detailed information about that element and/or various options (e.g., to define how a feature vector creation engine analyses elements of integration process flows, etc.). Selection of an “Edit” icon 2620 may also let an operator or administrator adjust the operation of the system (e.g., to change mapping to a data store, rules regulating automatic actions, set threshold values, etc.).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

1. A system associated with integration process flows in a cloud computing environment, comprising:
an integration process flow data store that contains information about a plurality of integration processes;
an integration process feature vector data store that contains information about a plurality of integration process feature vectors;
a feature vector creation engine, coupled to the integration process flow data store and the integration process feature vector data store, including:
a computer processor, and
a computer memory storing instructions that when executed by the computer processor cause the feature vector creation engine to:
retrieve information about a first integration process flow from the integration process flow data store,
automatically analyze the retrieved information about the first integration process flow to create a first integration process feature vector, and
store the first integration process feature vector into the integration process feature vector data store; and
a feature vector utilization engine, coupled to the integration process flow data store, to:
retrieve information about the first integration process feature vector and a second integration process feature vector from the integration process feature vector data store.

2. The system of claim 1, wherein the feature vector utilization engine is further to automatically perform an action based on the first and second integration process feature vectors.

3. The system of claim 2, wherein the first integration process feature vector is created based on multiple characteristics of the first integration process flow.

4. The system of claim 3, wherein the characteristics of the first integration process flow include at least one of: (i) integration process senders, (ii) integration process receivers, (iii) a number of integration process elements, (iv) types of integration process elements, (v) integration process conditions, and (vi) integration process messages.

5. The system of claim 3, wherein the characteristics of the first integration process flow include an adapter vector based on multiple types of integration process adapters, and for each type of integration process adapter, a number of times each type of adapter is present in the first integration process flow.

6. The system of claim 3, wherein the characteristics of the first integration process flow include a resource vector based on, for each of multiple types of integration process adapters, at least one of: (i) a Central Processing Usage (“CPU) resource usage, (ii) a memory resource usage, and (iii) an Input Output (“IO”) resource usage.

7. The system of claim 6, wherein the resource vector is used in connection with the automatically performed action to generate a worker application recommendation based on integration process flows, available worker applications, and available service bindings.

8. The system of claim 6, wherein the resource vector is used in connection with the automatically performed action to generate a service bindings recommendation based on integration process flows, available worker applications, and available service bindings.

9. The system of claim 6, wherein the resource vector is used in connection with the automatically performed action to generate an integration process flow recommendation based on integration process flows, available worker applications, and available service bindings.

10. The system of claim 6, wherein the resource vector is used in connection with the automatically performed action to generate an optimal orchestration plan based on integration process flows, available worker applications, and available service bindings.

11. The system of claim 10, wherein the resource vector is used in connection with the automatically performed action to generate an end-to-end optimal orchestration plan transformed into an understandable language for an orchestrator framework.

12. The system of claim 3, wherein the characteristics of the first integration process flow include a connection vector based on, for each of multiple types of integration process connectors, a number of times each type of connector is present in the first integration process flow.

13. The system of claim 3, wherein the characteristics of the first integration process flow include a usage statistics vector.

14. The system of claim 3, wherein the first integration process feature vector is created based on multiple feature vectors by: (i) combining the feature vectors, (ii) vector addition, (iii) weights for elements of the feature vector, or (iv) any other type of vector transformation.

15. The system of claim 2, wherein a distance between the first and second integration process feature vectors is used in connection with the automatically performed action to calculate a similarity score for the first and second integration process flows.

16. The system of claim 2, wherein the automatically performed action is to cluster integration process flows.

17. The system of claim 2, wherein the automatically performed action is to classify the first integration process flow.

18. The system of claim 17, wherein the classification of the first integration process flow is based on a business case associated with at least one of: (i) standard or nonstandard, (ii) safe or unsafe, (iii) CPU heavy or not CPU heavy, (iv) memory heavy or not memory heavy, (v) IO heavy or not IO heavy, and (xi) vulnerable or not vulnerable.

19. A computer-implemented method associated with integration process flows in a cloud computing environment, comprising:
retrieving, by a computer processor of a feature vector creation engine, information about a first integration process flow from an integration process flow data store that contains information about a plurality of integration processes;
automatically analyzing, by the feature vector creation engine, the retrieved information about the first integration process flow to create a first integration process feature vector based on multiple characteristics of the first integration process flow, including at least one of: (i) integration process senders, (ii) integration process receivers, (iii) a number of integration process elements, (iv) types of integration process elements, (v) integration process conditions, and (vi) integration process messages;
storing, by the feature vector creation engine, the first integration process feature vector into the integration process feature vector data store;
retrieving, by a feature vector utilization engine, information about the first integration process feature vector and a second integration process feature vector from the integration process feature vector data store; and
automatically performing, by the feature vector utilization engine, an action based on the first and second integration process feature vectors.

20. The method of claim 19, wherein the characteristics of the first integration process flow include: (i) an adapter vector, (ii) a resource vector, (iii) a connection vector, and (iv) a usage statistics vector.

21. One or more non-transitory computer-readable media storing computer-executable instructions that, when executed by a computing system, cause the computing system to perform operations for integration process flows in a cloud computing environment, comprising:
retrieving information about a first integration process flow from an integration process flow data store that contains information about a plurality of integration processes;
automatically analyzing, by a feature vector creation engine, the retrieved information about the first integration process flow to create a first integration process feature vector based on multiple characteristics of the first integration process flow;
storing, by the feature vector creation engine, the first integration process feature vector into an integration process feature vector data store;
retrieving, by a feature vector utilization engine, information about the first integration process feature vector and a second integration process feature vector from the integration process feature vector data store; and
automatically performing, by the feature vector utilization engine, an action based on the first and second integration process feature vectors.

22. The media of claim 21, wherein the first integration process feature vector is created based on multiple feature vectors by: (i) combining the feature vectors, (ii) vector addition, (iii) weights for elements of the feature vector, or (iv) any other type of vector transformation.

23. The media of claim 21, wherein a distance between the first and second integration process feature vectors is used in connection with the automatically performed action to calculate a similarity score for the first and second integration process flows.
